(19) United States
(12) Patent Application Publication
(10) Pub. No.: US 2025/0035904 A1
(43) Pub. Date: Jan. 30, 2025

(54) METHOD OF SETTING AN OPTICAL FOCUS AND MEDICAL DEVICE

(71) Applicant: Leica Microsystems CMS GmbH, Wetzlar (DE)

(72) Inventors: Oliver SCHLICKER, Wetzlar (DE); Markus SCHECHTER, Wetzlar (DE)

(21) Appl. No.: 18/782,059

(22) Filed: Jul. 24, 2024

(30) Foreign Application Priority Data
Jul. 24, 2023 (DE) 102023119496.8

(51) Int. Cl. G02B 21/24; G02B 7/36

(52) U.S. Cl. CPC G02B 21/244; G02B 7/36

(57) ABSTRACT

A first aspect of this disclosure relates to a computer-based method of setting an optical focus, comprising the steps of: obtaining a first threshold value for a drift of an optical focus, obtaining a first drift value, wherein it is based on measurements of at least one parameter regarding the focus at different points in time, comparing the first drift value with the first threshold value, outputting the first drift value if it exceeds the first threshold value inadmissibly.

### CROSS-REFERENCE TO RELATED APPLICATION

This application claims priority to German Application 102023119496.8, which was filed on Jul. 24, 2023. The content of this earlier filed application is incorporated by reference herein in its entirety.

### TECHNICAL FIELD

This disclosure relates to methods of setting an optical focus. Furthermore, medical devices are disclosed, e.g. microscopes whose optical focus may be operated with corresponding methods.

### BACKGROUND

An autofocus, e.g. in a microscope, is a function that allows the focus of an objective lens to be set automatically to ensure clear and sharp images. However, autofocus systems may be affected by a phenomenon called drift, which refers to the gradual shifting or movement of the focal plane over time. Drift may have a negative impact on the accuracy and reliability of the autofocus function.

Internal experience has shown that drift may be caused by various factors, e.g. mechanical vibrations, temperature variations and thermal expansion/contraction of microscope components. These factors may cause the microscope stage, the objective lens or other components to move, which can lead to a shift in the focal plane. Changes to the sample may also contribute to losing an initially set focus.

To solve problems caused by drift in focus-based systems, improvements are desirable.

### SUMMARY

One object of the embodiments of this disclosure is to improve an autofocus system.

This object is solved by the embodiments disclosed herein, which are defined in particular by the subject matter of the independent claims. The dependent claims relate to further embodiments. Various aspects and embodiments of these aspects are also disclosed in the summary and description below, which provide additional features and advantages.

A first aspect of this disclosure relates to a computer-based method of setting an optical focus, comprising the steps of:
obtaining a first threshold value for a drift of an optical focus;
obtaining a first drift value, wherein it is based on measurements of at least one parameter regarding the focus at different points in time;
comparing the first drift value with the first threshold value;
outputting the first drift value if it exceeds the first threshold value inadmissibly.

Drift is usually an error that is specific to an autofocus system operating in a particular situation. A drift is particularly noticeable if a sample is observed over longer periods of time, e.g. if an image series is to be created every 5 minutes in order to observe a development of a sample. An initially sharp perspective loses its sharpness over time. This drift is typically corrected with an optical focus by tracking the focus accordingly.

An optical focus may be included by various devices. An optical focus may be a focus system that operates with electromagnetic radiation, e.g. light beams, UV radiation. An optical focus may be included by a medical and/or diagnostic device, e.g. a microscope. An optical focus may also be included by an endoscopy system or an ophthalmoscopy system. Laser systems, e.g. laser surgery systems, may also have an optical focus. An optical focus may also be included by a photo camera or a video camera system.

A threshold value, in particular a first threshold value, may be received or retrieved, e.g. from a cloud, especially if the method is not performed by a computer of the optical focus (this will be explained in more detail later). A threshold value for an autofocus range refers to a predefined value or range that determines to which extent the autofocus system changes a new focus value in relation to an old focus value. A threshold value may be specified in absolute and/or relative terms. It can help define a criterion for determining whether an image is sharp or blurred based on certain measurements or parameters. A threshold value may be an absolute threshold value, e.g. a maximum value that must never be exceeded. In this case, any exceedance of the threshold value is an impermissible exceedance. A threshold value may also be a complex threshold value, e.g. a maximum value and/or an average value that may be exceeded temporarily and/or by a certain amount. In this case, the additional parameters (duration of exceedance, amount of exceedance) determine whether a drift value impermissibly exceeds the threshold value. A threshold value is used to check whether an identified new focus should be set. A threshold value may be used, for example, for a plausibility check of a newly identified focus.

A drift value, in particular a first drift value, may be received or retrieved (from a focus system) in a similar way to a threshold value. A drift value represents an autofocus that must be set in order to display an image sharply (again). Similar to a threshold value, a drift value may be specified in absolute or relative terms, i.e. in relation to another focus and/or drift value. A first drift value may consist of a single value. Alternatively, a drift value may consist of several values that were taken one immediately after the other.

A measured parameter regarding the focus may be, for example, a focal length, a distance of a sample to the objective and/or a set lens aperture. Additionally or alternatively, a parameter may be a reflection-based parameter, e.g. a position, a deviation or a wavelength of a reflected light beam.

A comparison of the first drift value with the first threshold value may be made in particular depending on the type of threshold value and/or drift value. A comparison may be made, for example, by calculating a difference. Additionally or alternatively, a comparison may also be made by correlating the two values. If the threshold value and the drift value are specified in different dimensions, at least one of the two values may be transformed accordingly in order to be able to compare the drift value with the threshold value.

A check as to whether a first drift value should be set and thus whether a previously set drift value should be replaced is based on the comparison of the first drift value with the first threshold value. If the first drift value is less than or equal to the first threshold value, the first drift value may be implemented by the autofocus system. The specification that the first drift value should be “less than or equal to” the threshold value is an embodiment-specific configuration. It may also be required that the first drift value is smaller than the first threshold value and that the first drift value is not output if the first drift value and the first threshold value are equal. In both cases, the threshold value represents a maximum threshold value. Alternatively, it may be determined that the drift value may exceed the first threshold value by a certain amount. In this case, the threshold value rather represents an average drift value.

The first drift value may be output in such a way that the optical focus may implement the first drift value. For example, the first drift value may be sent to the system that operates the optical focus (e.g., a microscope). Additionally or alternatively, the first drift value may also be output in such a way that the system operating the optical focus may fetch the first drift value. For example, the first drift value may be stored in a shared memory space, e.g. a cloud, which may be accessed by the system operating the optical focus.

One embodiment of the first aspect relates to a computer-based method of setting an optical focus, wherein the first threshold value is specified on the basis of at least one or more of the following parameters:
an information from the manufacturer of the device including the focus;
an information from the environment of the focus;
a sample-specific information.

Such an information may be provided by a manufacturer of a microscope, for example. Additionally or alternatively, such an information may be a temperature information. In particular, a temperature information may be obtained from a temperature sensor, which is included by the focus system that is to be set. Additionally or alternatively, such a temperature may be obtained from a temperature sensor which is operated in the environment, e.g. in a room, in which the focus system operates. An information for determining a threshold value may also be an exposure time of the sample. In particular, if the sample is negatively influenced by exposures, this can result in a threshold value, e.g. within the framework of a maximum exposure time or exposure rate. Additionally or alternatively, a property of a sample to be analyzed may represent an information on the basis of which a threshold value for a drift may result, this can be a viscosity, for example. This makes it possible to determine a specific threshold value. If device-specific and/or sample-specific values are provided from a database, it is possible to efficiently determine situation-specific threshold values.

One embodiment of the first aspect relates to a computer-based method of setting an optical focus, wherein the first drift value is based on image-based measurements of the focus performed one after the other.

An image-based measurement may be based in particular on images taken with the optical focus. Additionally or alternatively, an image-based measurement may be based on images taken by a separate imaging system. This is particularly possible because a drift, as described above, is based on changes in the focus system and/or the sample. If these changes are known and/or measured, a drift may be determined based on them.

An image-based drift measurement which relies on the hardware of the optical focus system may therefore be performed solely electronically and/or by software. Additionally, an image-based drift measurement may be a 2- or 3-dimensional drift measurement. An image-based measurement may also be a passive measurement in which a sensor measures environmental information alone, which is not based on a signal generated by the sensor.

One embodiment of the first aspect relates to a computer-based method of setting an optical focus, wherein the first drift value is based on laser-based measurements of the focus.

A laser-based drift measurement uses laser beams to measure a movement or change in position with high accuracy. In laser interferometry, a laser beam is split into two separate paths, one of which serves as a reference and the other interacts with the object to be measured, e.g. a sample. The resulting interference pattern is analyzed to determine the drift of the object.

In a drift measurement based on a laser tracking system, laser beams and optical sensors are used to measure a position and/or movement on a sample in three-dimensional space. A laser beam may either be directed at a sample or at a system comprising the optical focus. An optical sensor detects the reflection of the emitted laser beam and analyzes it to determine the drift of the object.

A laser-based drift measurement is an example of a reflection measurement. In addition, a laser-based drift measurement is an example of a 1-dimensional drift measurement if it only comprises a single laser beam. In contrast to passive (image-based) drift measurement, reflection-based drift measurement is an active drift measurement. Other light sources may also be used instead of a laser, e.g. an LED.

Since a laser-based drift measurement generally works with a high repetition rate, it may be used in particular for a focus holding device in which a focus position is controlled via the reflected laser beam. In contrast, the software-based drift measurement described above may be used as a focus finding device, in particular because more information is available via the sampled two or three dimensions, which may be used to find a correct focus.

One embodiment of the first aspect relates to a computer-based method of setting an optical focus, wherein the measurements of the focus are taken at different positions.

A drift measurement may be performed at different locations in a sample. For this purpose, measurements may take place simultaneously at different locations and/or one after the other, in particular such that the same locations are measured repeatedly. Then, a separate drift value may be determined for each of these locations, and/or a single drift value that applies to several locations. If images are to be taken at different positions of a sample, it may happen that there is no (more) sample at one of these positions. In case of a drift correction, the autofocus then attempts to focus on an empty environment. This can result in at least the subsequent images at this position having an incorrect focus. If foci from other positions are also determined on the basis of the focus determined at this position, then these foci are also incorrect.

Alternatively, this problem may also occur if the autofocus focuses on an incorrect value for another reason, e.g. due to contamination or damage to the sample or storage of the sample (e.g. a crack in a Petri dish). In particular, a method according to the first aspect may eliminate implausible foci resulting from one or more of these reasons.

One embodiment of the first aspect relates to a computer-based method of setting an optical focus, comprising the step of:
discarding the first drift value if it is equal to or exceeds the first threshold value.

A drift value obtained may exceed the threshold value for various reasons. On the one hand, a drift value may be implausible because it is certain or highly likely to have resulted from an incorrect situation. The drift value may then be discarded completely, i.e. forever.

However, a drift value may also exceed a threshold value because a threshold value was specified too small and changes, e.g. in the sample or in the microscope, may lead to drift values greater than the threshold value. This may happen in particular if rapid focusing is desired, e.g. to avoid phototoxicity of a sample. (Phototoxicity is damage to a sample caused by electromagnetic radiation, for example by exposure to infrared, visible or UV radiation). A resulting reduced focus search area in which a drift is detected and which may be accompanied by a reduced threshold value, may lead to a detected drift, e.g. at the edge of the focus search area, being discarded as unrealistic although it is realistic. In such a case in particular, the drift value cannot be output initially because it is greater than the threshold value. However, a further check, e.g. with another optical focus system (software focus, hardware focus), may reveal that the drift value is realistic after all. For this reason, a drift value may also be discarded only temporarily and, in particular, saved for later use.

One embodiment of the first aspect relates to a computer-based method of setting an optical focus, comprising the steps of:
obtaining a second drift value;
comparing the second drift value with the first threshold value;
outputting the second drift value if it does not exceed the first threshold value.

In particular, a second drift value may be detected after the first drift value, in particular, a second drift value may be detected at the same position as the first drift value. Additionally or alternatively, a second drift value may be detected concurrently, e.g. with another focus system (e.g. a hardware-based focus if the focus to be set is a software-based focus). The second drift value may be detected at the same position, in particular to obtain an integrated drift value with greater certainty. Additionally or alternatively, the second drift value may be detected at a different position.

A comparison of a second drift value with the first threshold value may enable an easy-to-implement and quick plausibility check. The second drift value may then be output according to the first drift value or, completely or temporarily, discarded. Alternatively, a second drift value may be saved for further use.

One embodiment of the first aspect relates to a computer-based method of setting an optical focus, comprising the steps of:
obtaining a second threshold value;
obtaining a second drift value;
comparing the second drift value with the second threshold value;
outputting the second drift value if it does not exceed the second threshold value.

A comparison of a second drift value with a second threshold value may enable a dynamic plausibility check. The second threshold value may be specified on the basis of the parameters already mentioned above and, in particular, may replace the first threshold value, at least temporarily. A second threshold value may also be specifically specified over a predetermined time section and/or depending on various positions.

One embodiment of the first aspect relates to a computer-based method of setting an optical focus, wherein the second threshold value is based on the first drift value, in particular if the first drift value is smaller than the first threshold value.

It may happen that an initially selected first threshold value is too large and therefore also validates unrealistic, incorrect drift values as realistic drift values. To avoid this, the second threshold value may be specified on the basis of the first drift value. In particular, this may be done in such a way that the second threshold value exceeds a specified absolute or relative value. For example, the second threshold value may be selected as a value that exceeds the first drift value by 5%, 10%, 20%, 50%, 100% or 1000%. This means it is always possible to select a threshold value that adapts to the current situation.

In particular, a second threshold value may be specified depending on a first drift value if the first drift value has been validated reliably. Reliable validation may be achieved, for example, by measuring the first drift value several times and then calculating an average value. A multiple measurement of the first drift value may be measured consecutively, in parallel, with the same optical focus and/or with a different optical focus. In particular, this may only be done at certain points in time in order to save resources and reduce phototoxicity. The second threshold value may then also be updated at these points in time.

One embodiment of the first aspect relates to a computer-based method of setting an optical focus, wherein the second threshold value is based on a laser-based measurement of the focus; and the determination of the second drift value is based on an image-based measurement of the focus, or vice versa.

In particular, the second threshold value may be provided by a laser-based measurement, which runs at a higher repetition frequency than the image-based measurement of the second drift value. A current value may then always be provided for the threshold, especially if the repetition frequency of the image-based focus determination is low in order to minimize phototoxicity. Instead of a laser-based measurement, another type of focus measurement may also be used to measure a second threshold value. Instead of an image-based measurement, another type of focus measurement may also be used to measure the second drift value.

One embodiment of the first aspect relates to a computer-based method of setting an optical focus, wherein the laser-based measurement of the focus is performed with a higher repetition frequency than the image-based measurement of the focus.

A repetition frequency of a threshold value determination that does not cause phototoxicity may be in particular <10 kHz. This applies in particular to laser-based or LED-based threshold value determination. An image-based measurement, in particular an image-based measurement causing phototoxicity, may be repeated <1s, <10s, <100s, <1 min, <5 min or <10 min.

One embodiment of the first aspect relates to a computer-based method of setting an optical focus, wherein the first threshold value and/or the second threshold value is determined by machine learning and on the basis of information in a database.

Based on a machine learning algorithm, e.g. a neural network, a determination of a threshold value may take place in an automated manner depending on various parameters (e.g., type of microscope, ambient temperature, type of sample). A fully connected single or multi-layer neural regression network may be used to determine a threshold value. The neural regression network may be a neural network with feedforward coupling, e.g. a multilayer perceptron. The parameters with which the network is trained and/or operated may be taken from a database.

A second aspect of this disclosure relates to a computer-based method of setting a search area for an optical focus, comprising the steps of:
obtaining a first search area for measurements regarding a focus;
obtaining a first drift value and/or a first focus value;
determining a second search area on the basis of at least one of the following information:
the first drift value;
the first focus value.

A focus search area is the area in which a focus is analyzed in order to determine a current focus and thus also a currently prevailing drift. A first search area may be specified in particular on the basis of a threshold value.

By determining a second search area on the basis of the first drift value and/or on the basis of a first focus value, a search area for an automatically operating optical focus may be automatically adjusted. In particular, a second search area may be selected to be larger by an absolute or relative value than the first drift value and/or the first focus value. A second search area may also be replaced by a continuous or quasi-continuous sequence of search areas that are based on a received and in particular a current drift value and/or focus value. This allows the search area to always be tracked in such a way that it corresponds to the current drift behavior and, in particular, does not waste time unnecessarily focusing on an area that contains no or only uninteresting structures.

To prevent a new drift value from not being detected if the second search area is set too low, a second search area may also be enlarged again. This may be done according to fixed times, for example. Additionally or alternatively, a focus search area may be enlarged if a new drift value is at the edge of a currently set focus search area. In particular, a second search area may be enlarged if a new drift value falls below a specified absolute or relative distance to an edge of a focus area. Additionally or alternatively, a focus search area may be enlarged if a threshold value for a detected drift is exceeded once or several times.

One embodiment of the second aspect relates to a computer-based method of setting a search area for an optical focus, comprising the steps of:
determining a threshold value for a drift of an optical focus, wherein the threshold value is based on the second search area;
obtaining a drift value, wherein it is based on measurements regarding the focus at different points in time;
comparing the drift value with the threshold value;
outputting the drift value if it does not exceed the threshold value.

A third aspect of this disclosure relates to a medical device, in particular a microscope, with autofocus, configured to:
perform a method according to any one of the previous embodiments; or
communicate with a device, in particular via an application user interface which performs a method according to any one of the previous embodiments.

A medical device may also be a laboratory device and/or a diagnostic device. In particular, an application user interface may be set up so that the medical device exchanges information with a central server, e.g. in a cloud. In particular, a method according to the first or second aspect may be operated in the cloud and, in particular, may cooperate with a plurality of medical devices to set their optical focuses.

### BRIEF DESCRIPTION OF THE FIGURES

Further advantages and features result from the following embodiments, some of which refer to the figures. The figures do not always show the embodiments to scale. The dimensions of the various features may be increased or decreased accordingly, in particular for clarity of the description. The figures are at least partially schematized for this purpose.

FIG. 1 shows a validation of a new drift value according to one embodiment of this disclosure.

FIG. 2 shows the adjustment of a focus search area according to one embodiment of this disclosure.

FIG. 3 shows a block diagram for a method according to one embodiment of this disclosure.

FIG. 4 shows a schematic illustration of a system for performing a method of this disclosure.

In the following description, reference is made to the accompanying figures, which form part of the disclosure and illustrate certain aspects and embodiments by which the present disclosure may be understood. Identical reference numerals refer to identical or at least functionally or structurally similar features.

In general, a disclosure of a described method also applies to a corresponding device for performing the method or a corresponding system comprising one or more devices, and vice versa. If, for example, a particular method step is described, a corresponding device may include a feature for performing the described method step, even if this feature is not expressly described or shown in the figure. If, on the other hand, a specific device is described on the basis of functional units, for example, a corresponding method may include one or more steps for performing the described functionality, even if these steps are not explicitly described or shown in the figures. Similarly, a system may include corresponding device features or features for performing a particular method step. The features of the various exemplary aspects and embodiments described above or below may be combined, unless expressly stated otherwise.

### DETAILED DESCRIPTION

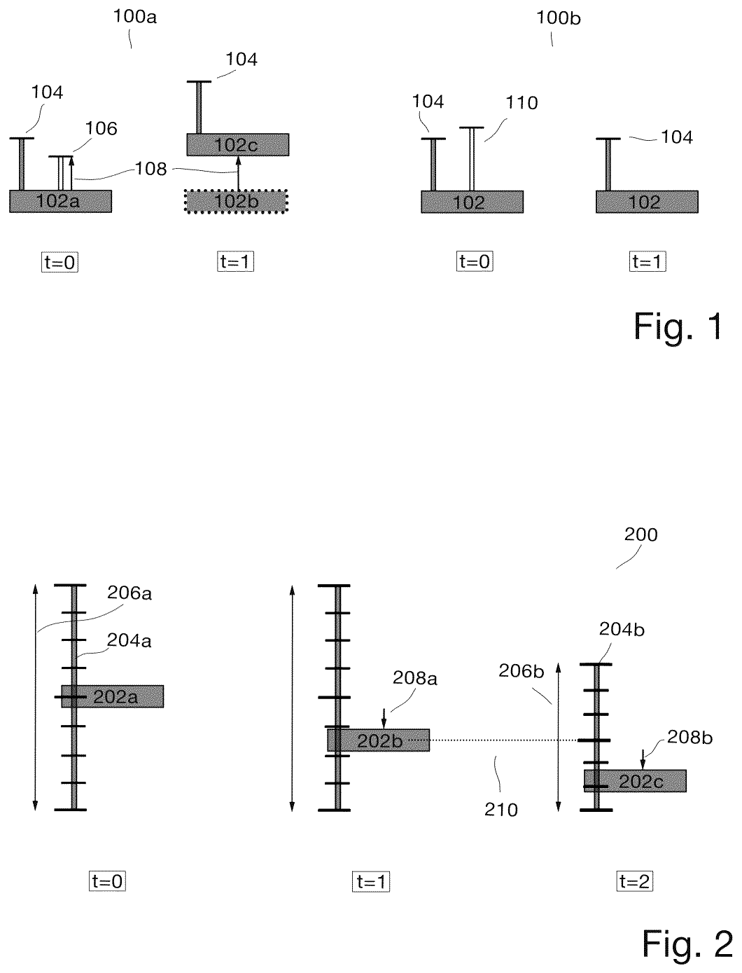

FIG. 1 shows a validation of a new drift value according to one embodiment of this disclosure using two scenarios. The scenarios show abstract settings of an optical focus of a microscope.

The first scenario 100a shows a validation of a newly detected drift value. At a point in time t=0, a sample 102a is located on a first focal plane. In addition, a threshold value 104 is shown relative to the focal plane 102a. The threshold value 104 indicates how strong an expected maximum drift of the sample is. A currently determined drift 106 is also shown relative to the sample 102. Such a drift may be performed in particular with a non-image-based focus system, e.g. a laser-based focus, to reduce/avoid phototoxicity of an analyzed sample. A comparison of the threshold value 104 with the detected drift value 106 shows that the drift value 106 is smaller than the expected maximum drift 104. In this case, the drift value may be validated because there is a plausible drift value. A parameter corresponding to the drift value 108 is then output to the autofocus of the microscope.

At the point in time t=1, the validated drift value 106 is implemented by the optical focus system of the microscope in a new focal plane 102c. The former focal plane of the sample is shown by the rectangle 102b with a dashed border. The change of focus in the perimeter of the drift 106 is shown by the arrows 108. The same threshold value 104 is again applied to the newly focused sample 102c in order to validate further drift movements. In the first scenario 100a, the drift is therefore within the expected drift. The sample is therefore shifted to the new focal plane by applying the validated drift. The threshold value 104 of the expected drift is also shifted accordingly.

In the second scenario 100b, a newly detected drift value is not validated. At a point in time t=0, the sample 102 is in turn located on a first focal plane. In addition, a threshold value 104 is shown relative to the sample 102, as in scenario 100a. A currently determined drift 110 is in turn shown relative to the sample 102 and/or its focal plane. A comparison of the threshold value 104 with the detected drift value 110 shows that the drift value 110 is greater than the expected maximum drift 104. In this case, the drift value may not be validated. There is a drift value that is not plausible. The drift value 106 is then not output to the autofocus of the microscope. At the point in time t=1, the focal plane of the optical focus of the microscope is still at the same location. If another drift value is available, it is compared again with the threshold value 104. In scenario 100b, the measured drift 106 is greater than the expected drift 104. The drift is therefore not applied and the sample remains in its position.

FIG. 2 shows the adjustment 200 of a focus search area according to one embodiment of this disclosure. At the point in time t=0, a sample is shown in a first focal plane 202a. New drift values are searched for in a first focus search area 204a which has a first width 206a.

At the point in time t=1, a new drift value 208a is detected in the first focus search area 204a and a new focal plane 202b is set for the sample. A new value for the focus search area is also output according to the new drift value 208a.

At the point in time t=2, the new focus search area 204b is used by the microscope. The new focus search area 204b has a width 206b that is smaller than the width 206a of the originally set focus search area. The width 206b of the new focus search area 204b was determined on the basis of the drift value 208a and is 700% of the drift value 208a. This makes it possible to determine the drift value more quickly than with the focus search area 204a. In addition, the new focus search area 204b is still large enough to detect also larger drifts. In addition, the center of the new focus search area 204b is located at height 210 at which the second focal plane 202b was aligned due to the detected drift 208a.

In the new focus search area 204b, a further drift 208b is detected and a third focal plane 202c is set for the sample accordingly.

In a further development of this embodiment, a threshold value, which is set as in FIG. 1 to check a detected drift, may also be specified on the basis of a detected drift value. Especially when the drift was detected with high measurement accuracy. Alternatively, the focus search area may also be specified on the basis of a specified threshold value.

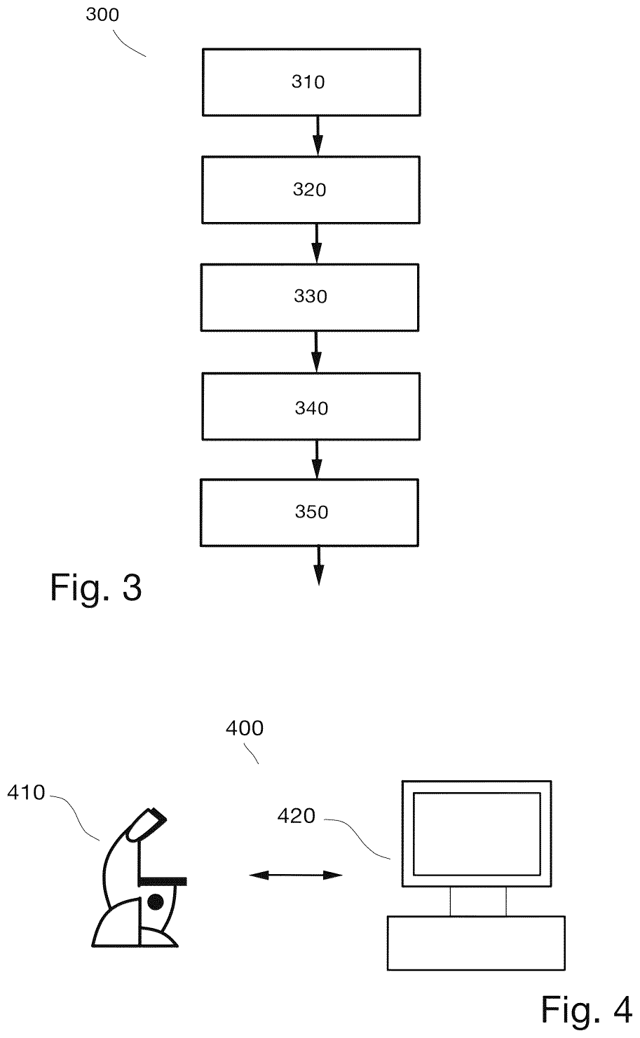

FIG. 3 shows a block diagram for a method 300 according to various embodiments of this disclosure.

In a first step 310, a first threshold value is determined. The first threshold value may be determined, for example, on the basis of an ambient temperature and/or on the basis of a drift specification from an optical focus manufacturer. In particular, the determination of the threshold value may take place in an automated manner using an algorithm based on machine learning. This may be a neural network, for example, which is continuously supplied with information from theory and/or practice in order to be able to predict drift values in certain situations. Such a learning algorithm may be operated on a central server and receive information about various optical foci that are operated decentrally, e.g. in a clinic or laboratory, in optical devices. Input and environmental information and actually measured drift values may be provided together such that the algorithm may learn and extrapolate the correlations for drift formation. Based on this, a threshold value, e.g. a maximum value, may then be determined for a drift.

In a second step 320, a first drift value is determined. This may be done using hardware and/or software-based focus measurement. The currently set focus may be compared with a focus to be newly set. If these are not the same or if the current image is blurred, then there is a drift. The drift measurement may be arranged in the device in which the optical focus to be set is operated, e.g. in a microscope. Additionally or alternatively, the drift measurement may be determined by an external device, e.g. a camera or a laser interferometer, which is operated in the vicinity of the optical focus.

In a next step 330, the measured first drift value is compared with the first threshold value. This may be done in a simple manner by calculating the difference between the drift value and the threshold value. If the threshold value is available as a statistical variable, e.g. as a distribution, a correlation may also be carried out, e.g. on the basis of a convolution. Depending on the type of threshold value (maximum drift value, average drift value), it may be required for a valid drift value that it is smaller or that it does not exceed the threshold value by a certain amount.

In a fourth step 340, outputting the first drift value if it does not permissibly exceed the first threshold value. A permissible exceedance may occur in particular if the drift value is made up of several values taken one after the other, and only one of these values exceeds the threshold value. A permissible exceedance may also occur if the threshold value is a statistical value which, in particular, may only be exceeded by a predetermined amount. For example, the threshold value may be an average drift value, and a measured drift value is still assumed to be plausible even if it exceeds the average drift value by 10%, 50% or 100%.

In a further step 350, an initially set focus search area is changed for the drift adjustment. This step may take place before step 340, in parallel to step 340 or after step 340. Similar to a threshold value, a focus search area may depend on various parameters. A focus search area may be determined, for example, on the basis of an ambient temperature and/or on the basis of a specification from an optical focus manufacturer. In particular, the determination of a focus search area may take place in an automated manner using an algorithm based on machine learning. In principle, this may be done in the same way as determining a threshold value.

The new focus search area is specified depending on the currently identified drift value. In particular, a focus search area may be 10%, 50%, 100% or 500% larger than a drift. In particular, a focus search area may only be specified on the basis of a validated drift value, i.e. a drift value that has been positively compared with a threshold value. Alternatively, the new focus search area may also be specified on the basis of a threshold value. A new focus may be determined more quickly and phototoxicity of the sample may be reduced are/or kept within tolerable limits by means of a focus search area that is specified based on a current drift value and/or a current threshold value.

Some embodiments relate to a microscope comprising a system as described in connection with one or more of FIGS. 1 to 3. Alternatively, a microscope may be part of a system or connected to a system as described in connection with one or more of FIGS. 1 to 3.

FIG. 4 shows a schematic illustration of a system 400 configured for performing a method described herein. The system 400 includes a microscope 410 and a computer system 420. The microscope 410 is configured to capture images and to be connected to the computer system 420. The computer system 420 is configured to perform at least a part of a method described herein. The computer system 420 may be configured to execute a machine learning algorithm. The computer system 420 and the microscope 410 may be separate entities, but may also be integrated into a common housing. The computer system 420 may be part of a central processing system of the microscope 410 and/or the computer system 420 may be part of a subcomponent of the microscope 410, such as a sensor, an actuator, a camera, or an illumination unit, etc. of the microscope 410.

The computer system 420 may be a local computer device (e.g., personal computer, laptop, tablet computer, or cell phone) having one or more processors and one or more storage devices, or may be a distributed computer system (e.g., a cloud computer system having one or more processors and one or more storage devices distributed at various locations, e.g. at a local client and/or one or more remote server farms and/or data centers). The computer system 420 may comprise any circuit or combination of circuits. In one embodiment, the computer system 420 may include one or more processors, which may be of any type. The term “processor” as used herein may refer to any type of computing circuit, such as a microprocessor, a microcontroller, a CISC microprocessor (complex instruction set computing), a RISC microprocessor (reduced instruction set computing), a VLIW microprocessor (very long instruction word), a graphics processor, a digital signal processor (DSP), a multicore processor, a FPGA (field programmable gate array), e.g., of a microscope or microscope component (e.g., camera), or any other type of microscope (e.g., camera) or any other type of processor or processing circuit. Other types of switching circuits that may be included in the computer system 420 may be a customized switching circuit, an application-specific integrated circuit (ASIC), or the like, such as one or more switching circuits (e.g., a communication switching circuit) for use in wireless devices such as cell phones, tablet computers, laptop computers, two-way radios, and similar electronic systems. The computer system 420 may include one or more storage devices, which may include one or more memory elements suitable for the respective application, such as a main memory in the form of random access memory (RAM), one or more hard disks, and/or one or more drives that process removable media such as compact disks (CD), flash memory cards, digital video disks (DVD), and the like. The computer system 420 may also include a display device, one or more speakers, and a keyboard and/or a control device, which may include a mouse, a trackball, a touch screen, a voice recognition device, or another device that allows a system user to input information into and receive information from the computer system 420.

Some or all method steps may be executed by (or using) a hardware device, like for example a processor, a microprocessor, a programmable computer or an electronic circuit. In some embodiments, one or more of the most important method steps may be executed by such a device.

Depending on certain implementation requirements, embodiments of the invention may be implemented in hardware or in software. The implementation may be performed using a non-transitory storage medium such as a digital storage medium, such as a floppy disk, a DVD, a Blu-Ray, a CD, a ROM, a PROM, an EPROM, an EEPROM, or a FLASH memory, on which electronically readable control signals are stored that interact (or are capable of interacting) with a programmable computer system such that the respective method is performed. Therefore, the digital storage medium may be computer readable.

Some embodiments of the invention include a data carrier having electronically readable control signals that are capable of interacting with a programmable computer system so as to perform any of the methods described herein.

In general, embodiments of the present invention may be implemented as a computer program product having a program code, the program code serving to perform any of the methods when the computer program product is running on a computer. For example, the program code may be stored on a machine-readable carrier.

Further embodiments include the computer program for performing any of the methods described herein stored on a machine-readable carrier.

In other words, an embodiment of the present invention is therefore a computer program having a program code for performing any of the methods described herein when the computer program is running on a computer.

Thus, another embodiment of the present invention is a storage medium (or a data carrier or a computer readable medium) on which the computer program for executing any of the methods described herein is stored when executed by a processor. The data carrier, the digital storage medium or the recorded medium are usually tangible and/or non-transferable. Another embodiment of the present invention is a device as described herein including a processor and the storage medium.

Thus, another embodiment of the invention is a data stream or a sequence of signals representing the computer program for performing any of the methods described herein. For example, the data stream and/or the signal sequence may be configured such that it may be transmitted over a data communication link, such as the Internet.

Another embodiment comprises a processing means, e.g., a computer or programmable logic device, configured or adjusted such that it that may perform any of the methods described herein.

Another embodiment includes a computer having installed thereon the computer program for performing any of the methods described herein.

Another embodiment of the invention includes a device or a system configured to transmit (e.g., electronically or optically) a computer program to a receiver for performing any of the methods described herein. For example, the receiver may be a computer, a mobile device, a storage device, or the like. For example, the device or system may include a file server for transferring the computer program to the receiver.

In some embodiments, a programmable logic device (e.g., a field programmable gate array) may be used to perform some or all of the functions of the methods described herein. In some embodiments, a field programmable gate array may cooperate with a microprocessor to perform any of the methods described herein. In general, the methods are preferably performed by any hardware device.

The term “and/or” as used herein includes all combinations of one or more of the listed aspects and may be abbreviated using “/”.

Although some aspects have been described in the context of a device, it is clear that these aspects also represent a description of the corresponding method, where a block or a device corresponds to a method step or a feature of a method step. Similarly, aspects described in connection with a method step also represent a description of a corresponding block or element or feature of a corresponding device.

Embodiments may be based on the use of a machine learning model or a machine learning algorithm. Machine learning may refer to algorithms and statistical models that computer systems may use to perform a specific task without explicit instructions, relying instead on models and inferences. In machine learning, for example, instead of a rule-based transformation of data, a transformation of data derived from an analysis of historical and/or training data may be used. For example, the content of images may be analyzed with the help of a machine learning model or a machine learning algorithm. To enable the machine learning model to analyze the content of an image (or another parameter), the machine learning model may be trained using training images as input and training content information as output. By training the machine learning model with a large number of training images and/or training sequences (e.g., words or sentences) and associated training content information (e.g., labels or annotations), the machine learning model “learns” to recognize the content of the images so that the content of images not included in the training data may be recognized using the machine learning model. The same principle may also be used for other types of sensor data: By training a machine learning model with training sensor data and a desired output, the machine learning model “learns” a transformation between the sensor data and the output, which may be used to provide an output based on non-training sensor data provided to the machine learning model. The data provided (e.g., sensor data, metadata and/or image data) may be pre-processed to obtain a feature vector, which is used as input for the machine learning model.

Machine learning models may be trained with the help of training data. In the above examples, a training method known as “supervised learning” is used. In supervised learning, the machine learning model is trained using a plurality of training samples, wherein each sample may include a plurality of input data values and a plurality of desired output values, i.e. each training sample is associated with a desired output value. By specifying both training patterns and desired output values, the machine learning model “learns” which output value it should provide based on an input pattern that is similar to the patterns provided during training. In addition to supervised learning, semi-supervised learning may also be used. In semi-supervised learning, some of the training patterns lack a corresponding desired output value. Supervised learning may be based on a supervised learning algorithm (e.g. a classification algorithm, a regression algorithm or a similarity learning algorithm). Classification algorithms may be used when the output values are restricted to a limited set of values (categorical variables), i.e., the input is associated with one of the limited set of values. Regression algorithms may be used if the outputs may have an arbitrary numerical value (within a range). Similarity learning algorithms may be similar to both classification and regression algorithms, but are based on learning from examples using a similarity function that measures how similar or related two objects are. In addition to supervised or semi-supervised learning, unsupervised learning may also be used to train the machine learning model. In unsupervised learning, (only) input data may be provided, and an unsupervised learning algorithm may be used to find a structure in the input data (e.g., by grouping or clustering the input data, finding commonalities in the data). Clustering is the assignment of input data comprising a plurality of input values into subsets (clusters) so that input values within the same cluster are similar according to one or more (predefined) similarity criteria, while they differ from input values comprised in other clusters.

Reinforcement learning is a third group of machine learning algorithms. In other words, reinforcement learning may be used to train the machine learning model. In reinforcement learning, one or more software actors (so-called “software agents”) are trained to perform actions in an environment. A reward is calculated based on the actions performed. In reinforcement learning, one or more software agents are trained to choose the actions in such a way that the cumulative reward is increased, resulting in the software agents becoming better in accomplishing the task they are given (which is reflected in increasing rewards).

In addition, some techniques may be applied to some of the machine learning algorithms. For example, feature learning may be used. In other words, the machine learning model may be trained at least partially with the help of feature learning and/or the machine learning algorithm may include a feature learning component. Feature learning algorithms, which may also be referred to as representation learning algorithms, may preserve the information in their inputs but also transform it such that it becomes useful, often as a pre-processing step before performing classifications or predictions. The learning of features may be based on main component analysis or cluster analysis, for example.

In some examples, the detection of anomalies (i.e., of outliers) may be used, which aims to identify input values that raise suspicion because they differ significantly from the majority of the input or training data. In other words, the machine learning model may be trained at least partially with the help of anomaly detection and/or the machine learning algorithm may include an anomaly detection component.

In some examples, the machine learning algorithm may use a decision tree as a prediction model. In other words, the machine learning model may be based on a decision tree. In a decision tree, observations about an element (e.g., a set of input values) may be represented by the branches of the decision tree, and an output value corresponding to the element may be represented by the leaves of the decision tree. Decision trees may support both discrete values and continuous values as output values. If discrete values are used, the decision tree may be referred to as a classification tree, if continuous values are used, the decision tree may be referred to as a regression tree.

Association rules are another technique that may be used in machine learning algorithms. In other words, the machine learning model may be based on one or more association rules. Association rules are created by identifying relationships between variables in large amounts of data. The machine learning algorithm may identify and/or use one or more relational rules that represent the knowledge derived from the data. The rules may be used, for example, to store, manipulate or apply the knowledge.

Machine learning algorithms are generally based on a machine learning model. In other words, the term “machine learning algorithm” may refer to a set of instructions that may be used to create, train or use a machine learning model. The term “machine learning model” may refer to a data structure and/or a set of rules representing the learned knowledge (e.g. based on the training performed by the machine learning algorithm). In some embodiments, the use of a machine learning algorithm may imply the use of an underlying machine learning model (or multiple underlying machine learning models). The use of a machine learning model may mean that the machine learning model and/or the data structure/rule set representing the machine learning model has been trained by a machine learning algorithm.

The machine learning model may be an artificial neural network (ANN), for example. ANNs are systems based on biological neural networks, such as those found for instance in the retina or the brain. ANNs consist of a plurality of interconnected nodes and a variety of connections, so-called edges, between the nodes. There are usually three types of nodes: input nodes that receive input values, hidden nodes that are (only) connected to other nodes, and output nodes that provide output values. Each node may represent an artificial neuron. Each edge may transfer information from one node to another. The output of a node may be defined as a (non-linear) function of its inputs (e.g., the sum of its inputs). The inputs of a node may be used in the function on the basis of a “weight” of the edge or node providing the input. The weighting of nodes and/or edges may be adjusted during the learning process. In other words, training an artificial neural network may comprise adjusting the weights of the nodes and/or edges of the artificial neural network, i.e., to achieve a desired output for a given input.

Alternatively, the machine learning model may be a support vector machine, a random forest model or a gradient boosting model. Support vector machines (i.e., support vector networks) are supervised learning models with associated learning algorithms that may be used to analyze data (e.g. for classification or regression analyses). Support vector machines may be trained by providing an input with a plurality of training input values that belong to one of two categories. The support vector machine may be trained to assign a new input value to one of the two categories. Alternatively, the machine learning model may also be a Bayesian network, which is a probabilistic, directed acyclic graphical model. A Bayesian network may represent a set of random variables and their conditional dependencies using a directed acyclic graph. Alternatively, the machine learning model may be based on a genetic algorithm, a search algorithm and a heuristic technique that mimics the process of natural selection.

List of Reference Numerals

| 100a | first scenario for validation |
|---|---|
| 100b | second scenario for validation |
| 102 | sample at original focal plane |
| 102a | sample at original focal plane |
| 102b | focal plane before drift |
| 102c | drift-corrected focal plane |
| 104 | threshold value |
| 106 | first drift value |
| 108 | change in focal plane according to the drift |
| 110 | first drift value |
| 200 | adjustment of focus search area |
| 202a | first focal plane |
| 202b | second focal plane |
| 202c | third focal plane |
| 204a | first focus search area |
| 204b | second focus search area |
| 206a | width of the first focus search area |
| 206b | width of the second focus search area |
| 208a | first drift value |
| 208b | second drift |
| 210 | reference height |
| 300 | method of focusing |
| 310 | determination of first threshold value |
| 320 | measurement of first drift value |
| 330 | comparison of first drift value with first threshold value |
| 340 | outputting a valid drift value |
| 350 | updating focus search area |
| 400 | microscope system |
| 410 | microscope |
| 420 | computer |

1. A computer-based method of setting an optical focus, comprising the steps of:
obtaining a first threshold value for a drift of an optical focus;
obtaining a first drift value, wherein it is based on measurements of at least one parameter regarding the focus at different points in time;
comparing the first drift value with the first threshold value;
outputting the first drift value if it exceeds the first threshold value inadmissibly.

2. The method according to claim 1, wherein the first threshold value is specified on the basis of at least one or more of the following parameters:
an information from the manufacturer of the device including the focus;
an information from the environment of the focus;
a sample-specific information.

3. The method according to claim 1,
wherein the first drift value is based on image-based measurements of the focus performed one after the other.

4. The method according to claim 1,
wherein the first drift value is based on laser-based measurements of the focus.

5. The method according to claim 1,
wherein the measurements of the focus are taken at different positions.

6. The method according to claim 1, comprising the step of:
discarding the first drift value if it is equal to or exceeds the first threshold value.

7. The method according to claim 1, comprising the steps of:
obtaining a second drift value;
comparing the second drift value with the first threshold value;
outputting the second drift value if it does not exceed the first threshold value.

8. The method according to claim 1, comprising the steps of:
obtaining a second threshold value;
obtaining a second drift value;
comparing the second drift value with the second threshold value;
outputting the second drift value if it does not exceed the second threshold value.

9. The method according to the previous claim,
wherein the second threshold value is based on the first drift value, in particular if the first drift value is smaller than the first threshold value.

10. The method according to claim 8,
wherein the second threshold value is based on a laser-based measurement of the focus; and the determination of the second drift value is based on an image-based measurement of the focus, or vice versa.

11. The method according to claim 10,
wherein the laser-based measurement of the focus is performed with a higher repetition frequency than the image-based measurement of the focus.

12. The method according to claim 1,
wherein the first threshold value and/or the second threshold value is determined by machine learning and on the basis of information in a database.

13. A computer-based method of setting an optical focus, comprising the steps of:
obtaining a first search area for measurements regarding a focus;
obtaining a first drift value and/or a first focus value;
determining a second search area on the basis of at least one of the following information:
the first drift value;
the first focus value.

14. The method of claim 13, comprising the steps of:
determining a threshold value for a drift of an optical focus, wherein the threshold value is based on the second search area;
obtaining a drift value, wherein it is based on measurements regarding the focus at different points in time;
comparing the drift value with the threshold value;
outputting the drift value if it does not exceed the threshold value.

15. A medical device, in particular microscope, with autofocus, configured to perform the method of claim 1.

16. A medical device, in particular microscope, with autofocus and configured to communicate with a device, in particular via an application user interface which performs the method of claim 1.
